(19) United States
(12) Patent Application Publication
(10) Pub. No.: US 2007/0157839 A1
(43) Pub. Date: Jul. 12, 2007

(54) Black matrix of color filter and method of manufacturing the black matrix

(75) Inventors: Wou-Sik Kim, Suwon-si (KR); Seong-jin Kim, Seongnam-si (KR); Tae-Woon Cha, Seoul (KR); Seung-Joo Shin, Seoul (KR)

Correspondence Address: STANZIONE & KIM, LLP, 919 18TH STREET, N.W., SUITE 440, WASHINGTON, DC, 20006, US

(73) Assignee: Samsung Electronics Co. Ltd., Suwon-si (KR)

(21) Appl. No.: 11/583,831

(22) Filed: Oct. 20, 2006

(30) Foreign Application Priority Data
Jan. 6, 2006 (KR) 2006-1675

(51) Int. Cl. B41F 33/00

(52) U.S. Cl. 101/483

(57) ABSTRACT

A black matrix used with color filters and a method of manufacturing the black matrix. The black matrix is formed on a substrate and defines a plurality of pixel regions. The black matrix has an ink-phobic upper surface having a plurality of nano-sized grooves formed therein, and ink-philic lateral surfaces.

### CROSS-REFERENCE TO RELATED APPLICATIONS

This application claims priority under 35 U.S.C. §119(a) from Korean Patent Application No. 10-2006-0001675, filed on Jan. 6, 2006, in the Korean Intellectual Property Office, the disclosure of which is incorporated herein in its entirety by reference.

### BACKGROUND OF THE INVENTION

1. Field of the Invention

The present general inventive concept relates to a black matrix of a color filter, and more particularly, a black matrix of color filters by which ink mixture between pixels of a color filter can be prevented and the color reproducibility and contrast ratio of the color filter can be improved, and a method of manufacturing the black matrix.

2. Description of the Related Art

Until recently, cathode ray tube (CRT) monitors have been usually used to display information from TVs and computers. Recently however, flat panel displays, such as liquid crystal displays (LCDs), plasma display panels (PDPs), electro-luminescence (EL) displays, light emitting diodes (LEDs), or field emission displays (FEDs), are being used with a recent increase in the sizes of screens. Among these flat panel displays LCDs are widely used as desk-top computer monitors, lap-top computer monitors, etc., because of low power consumption.

Generally, LCDs include a color filter that forms images of desired colors by transmitting white light modulated by a liquid crystal layer. To manufacture a color filter, first, a black matrix having a predetermined shape is formed on a transparent substrate, and then inks of predetermined colors, such as red (R), green (G), and blue (B), are injected into pixel regions defined by the black matrix using an inkjet printing method, for example, to form pixels of the predetermined colors.

In the manufacture of the color filter, when an upper surface and a lateral surface of the black matrix are both ink-philic, ink injected into each pixel region may overflow onto the upper surface of the black matrix, and thus color mixture between pixels may occur. On the other hand, when the upper surface and the lateral surface of the black matrix are both ink-phobic, the ink mixture between pixels can be prevented, but ink injected within each pixel region cannot have a uniform thickness due to the lack of wetting of the lateral surface of the black matrix with ink. Hence, light leakage around the lateral surfaces of the black matrix may occur, consequently degrading the color reproducibility and the contrast ratio of the color filter.

Therefore, to address the ink mixture and light leakage problems, it is desirable to render the upper surface of the black matrix ink-phobic and the lateral surface thereof ink-philic.

### SUMMARY OF THE INVENTION

The present general inventive concept provides a black matrix for color filters by which ink mixture between pixels of a color filter can be prevented and the color reproducibility and contrast ratio of the color filter can be improved, and a method of manufacturing the black matrix.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing a black matrix used with color filters that is formed on a substrate and defines a plurality of pixel regions, the black matrix including an upper surface having a plurality of nano-sized grooves formed therein and being ink-phobic, and lateral surfaces being ink-philic.

The black matrix may be formed of an ink-philic material. The black matrix may be formed of a polymer-based organic resin.

Each of the grooves may be 20-200 nm in size and 1000-100000 nm² in cross-sectional area. The grooves may occupy 20-50% of the upper surface. Each of the grooves may be 50-200 nm in depth.

The foregoing and/or other aspects and utilities of the present general inventive concept are also achieved by providing a color filter including a substrate, a black matrix formed on the substrate and defining a plurality of pixel regions, and ink of predetermined colors filled within the pixel regions and the black matrix includes an upper surface having a plurality of nano-sized grooves formed therein and being ink-phobic, and lateral surfaces being ink-philic.

The foregoing and/or other aspects and utilities of the present general inventive concept are also achieved by providing a method of manufacturing a black matrix used with color filters, the method including forming a light shade layer of an ink-philic material on a substrate, patterning the light shade layer to define a plurality of pixel regions on the substrate, and forming a black matrix by forming nano-sized grooves on an upper surface of the patterned light shade layer using a nano-imprinting process.

The forming of the light shade layer may include coating the ink-philic material on the substrate, and soft baking the ink-philic material.

The method may further include hard baking the patterned light shade layer after the patterning of the light shade layer.

The nano-imprinting process may be executed during the hard baking of the patterned light shade layer.

The forming of the grooves using the nano-imprinting process may include installing a stamp over the patterned light shade layer, the stamp having nano-sized protrusions formed on its bottom, pressing the stamp down on the upper surface of the patterned light shade layer so as to form grooves having shapes depending on the shapes of the protrusions on the stamp in the upper surface of the patterned light shade layer, and separating the stamp from the light shade layer.

The stamp may-be formed of a material selected from the group consisting of glass, quartz, silicon (Si), and poly(dimethylsiloxane) (PDMS).

The foregoing and/or other aspects and utilities of the present general inventive concept are also achieved by providing a black matrix used with a color filter defining a plurality of pixel regions, the black matrix including an ink-phobic upper surface, and ink-philic lateral surfaces formed of a same material as the upper surface.

The ink-phobic upper surface may include a plurality of grooves.

The foregoing and/or other aspects and utilities of the present general inventive concept are also achieved by providing a method of manufacturing a black matrix used with a color filter, the method including patterning a layer on a substrate to define a plurality of pixel regions, and forming a plurality of nano-sized grooves on a top surface of the patterned layer top form ink-phobic regions.

The patterned layer may include an ink-philic material, and the patterning of the layer may include coating the ink-philic material on the substrate, and soft-baking the ink-philic material on the substrate.

The patterning of the layer may further include hard-baking the patterned layer.

The forming of the plurality of grooves may include pressing a bottom surface of a stamp having a plurality of protrusions to the top surface of the layer, and separating the stamp from the layer to create grooves corresponding to the plurality of protrusions on the top surface of the layer.

The forming of the plurality of grooves may be performed during the hard-baking of the patterned layer.

The forming of the plurality of grooves may be performed during the soft-baking of the patterned layer.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating a black matrix of a color filter according to an embodiment of the present general inventive concept;

FIG. 2 illustrates a cross-section of the black matrix illustrated in FIG. 1;

FIG. 3 illustrates a color filter manufactured using the black matrix illustrated in FIGS. 1 and 2; and

FIGS. 4A through 4D are cross-sectional views illustrating a method of manufacturing the black matrix shown in FIGS. 1 and 2.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

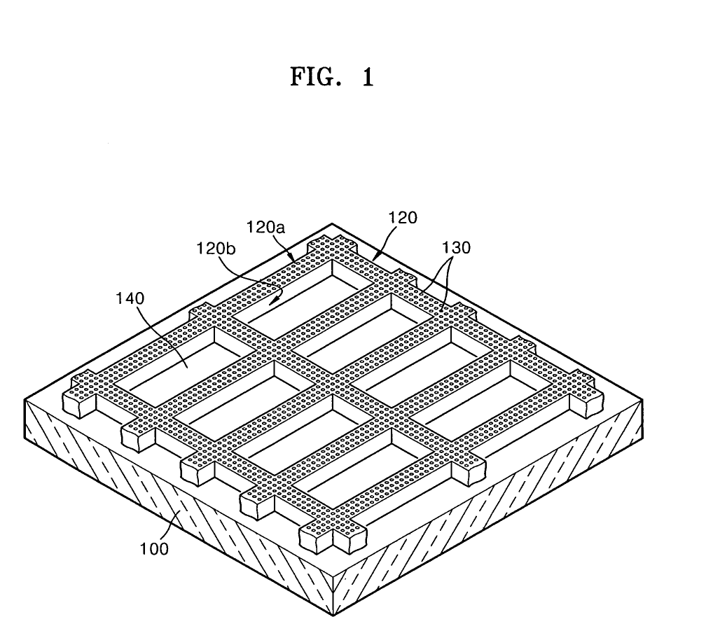

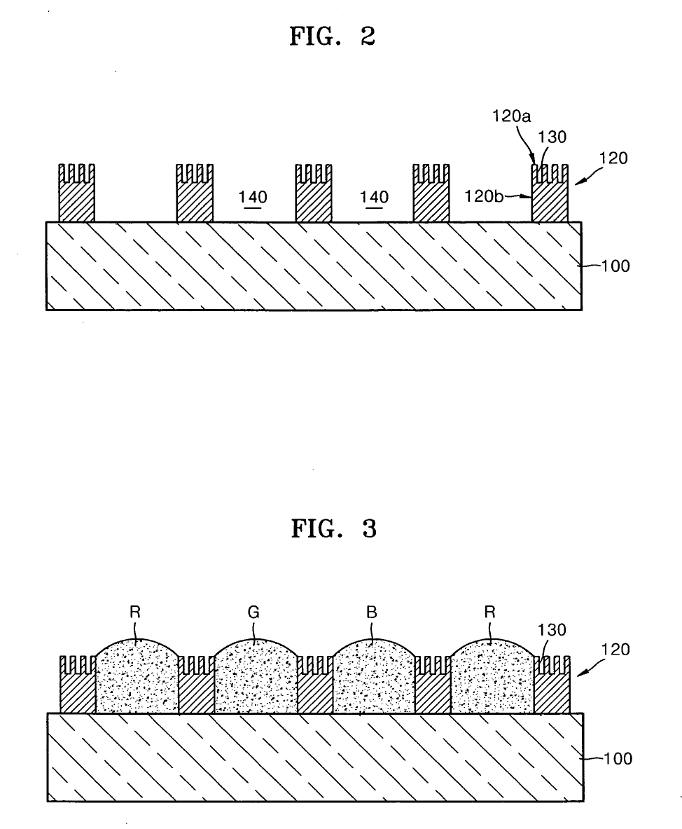

FIG. 1 is a perspective view illustrating a black matrix 120 of a color filter according to an embodiment of the present general inventive concept. FIG. 2 illustrates a cross-section of the black 120 matrix illustrated in FIG. 1.

Referring to FIGS. 1 and 2, the black matrix 120 having a predetermined shape is formed on a substrate 100. A plurality of pixel regions 140 are defined on the substrate 100 by the black matrix 120. Each of the pixel regions 140 is filled with ink of a predetermined color, and thus pixels are formed. Consequently, a color filter made up of the pixels is formed.

The substrate 100 is transparent, and a glass substrate or a plastic substrate may be used as the transparent substrate 100. The black matrix 120 may be formed of an ink-philic material. For example, the black matrix 120 may be formed of a polymer-based organic resin. The black matrix 120 may have a height of about 1.5 μm and a width of about 30 μm.

An upper surface 120a of the black matrix 120 may have a concave-convex structure. More specifically, nano-sized grooves 130 may be formed on the upper surface 120a of the black matrix 120. While FIG. 1 illustrates the grooves 130 as having circular horizontal cross-sections, the present general inventive concept is not limited thereto, and the cross-sections of the grooves 130 may have various other cross-section shapes. In the present embodiment, the grooves 130 may occupy 20-50% of the upper surface 120a of the black matrix 120. Each of the grooves 130 may be about 20-200 nm in size and about 1000-100000 nm², in cross-sectional area, for example 5000-10000 nm². The size of each of the grooves 130 denotes the diameter of each groove 130 or a maximum distance between inner walls of each groove 130. The depth of each of the grooves 130 may be about 50-200 nm.

When the nano-sized grooves 130 are formed on the upper surface 120a of the black matrix 120, the upper surface 120a is rendered ink-phobic. The upper surface 120a of the black matrix 120 formed of an ink-philic material has an ink-phobic characteristics due to a lotus effect. More specifically, when the nano-sized grooves 130 are formed on the upper surface 120a of the black matrix 120, the upper surface 120a is made up of a surface of the material of the black matrix 120 and air filled within the grooves 130. Accordingly, when the nano-sized grooves 130 are formed on the upper surface 120a of the black matrix 120, an area of the upper surface 120a that contacts ink is reduced compared with when the upper surface 120a of the black matrix 120 has no concave-convex structures, that is, is flat. Hence, a surface energy on the upper surface 120a in which the grooves 130 are formed is reduced, and a contact angle with respect to ink is increased. Consequently, the upper surface 120a having the grooves 130 is rendered ink-phobic. For example, given that the contact angle of a flat plane formed of a certain material with respect to ink is 10°, when nano-sized grooves are formed on the flat plane so that air occupies 30% of the flat plane, the contact angle of the plane having the grooves with respect to ink is increased to about 67°.

As described above, the upper surface 120a of the black matrix 120 is processed to have a concave-convex structure using a physical method instead of changing the component of the black matrix 120 or chemically processing the surface of the black matrix 120, so that the upper surface 120a of the black matrix 120 is rendered ink-phobic.

Lateral surfaces 120b of the black matrix 120 formed of the ink-philic material are kept ink-philic.

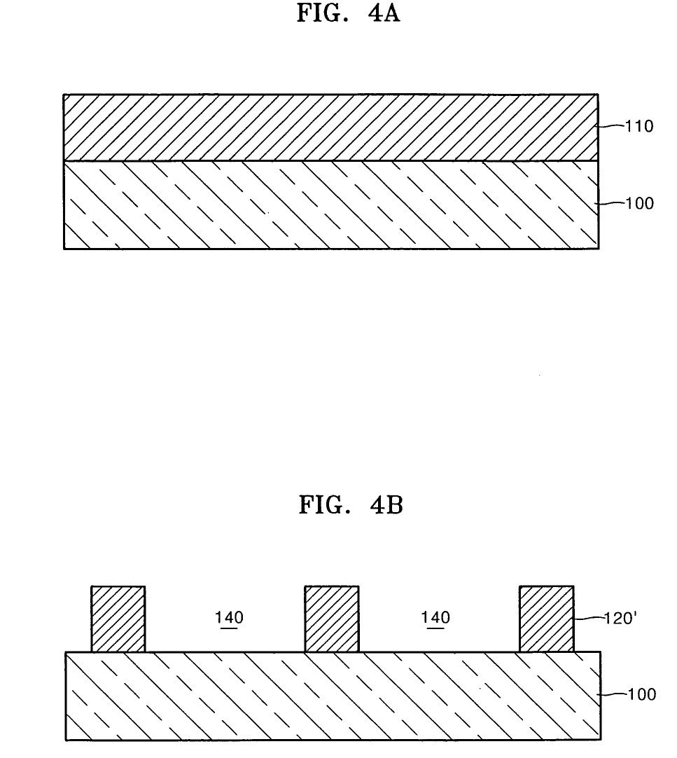

FIG. 3 illustrates a color filter manufactured using the black matrix 120 of FIGS. 1 and 2. Referring to FIG. 3, the color filter includes the substrate 100, the black matrix 120 formed on the substrate 100 and defining pixel regions, and ink of predetermined colors, such as, red (R), green (G), and blue (B), filled in the pixel regions.

As described above, since the upper surface 120a of the black matrix 120 has the nano-sized grooves 130 formed therein, the upper surface 120a is ink-phobic. Accordingly, when pixels are formed by injecting ink into the pixel regions using an inkjet printing method, for example, color mixture between pixels can be prevented. In addition, since the lateral surfaces 120b of the black matrix 120 are ink-philic, ink can be injected within the pixel regions to have uniform thicknesses. Hence, the color reproducibility and the contrast ratio of the color filter can be improved.

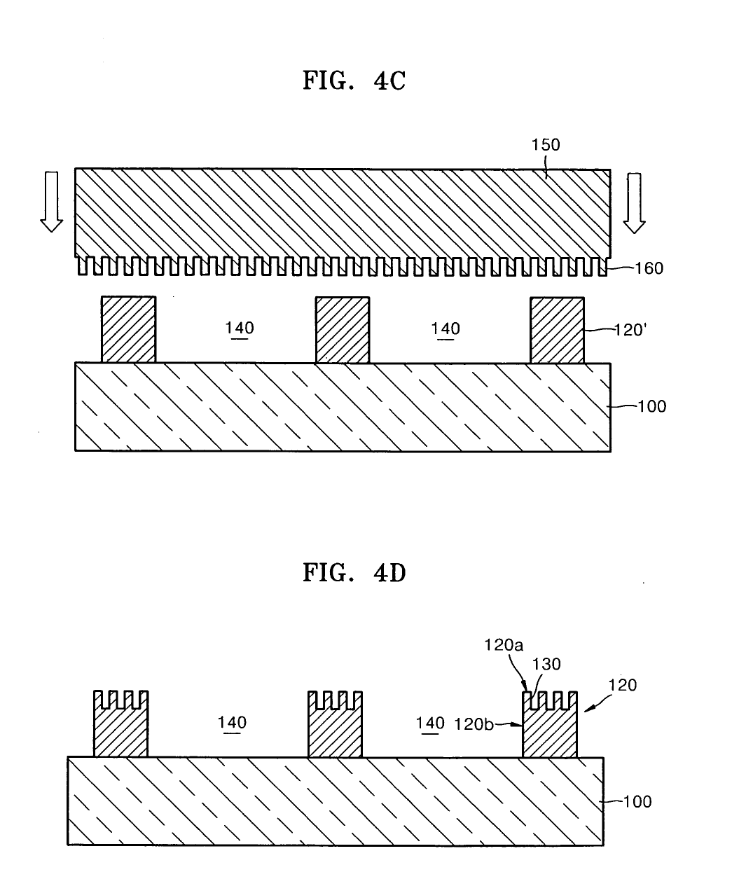

FIGS. 4A through 4D are cross-sectional views illustrating a method of manufacturing the black matrix 120. Referring to FIG. 4A, a light shade layer 110 formed of an ink-philic material is formed on the substrate 100. The light shade layer 110 may be formed by coating the ink-philic material to a predetermined thickness on the substrate 100 and soft baking the same. The substrate 100 is transparent and may be a glass substrate or a plastic substrate. The ink-philic material may be polymer-based organic resin. The ink-philic material may be coated on the substrate 100 using a method, such as spin coating, die coating, or dip coating. The soft baking may be executed at about 80-120° C. for about 30 seconds to 2 minutes.

Referring to FIG. 4B, the light shade layer 110 is patterned into a patterned light shade layer 120′. The patterned light shade layer 120′ defines a plurality of pixel regions 140 on the substrate 100. When the light shade layer 110 is formed of a photosensitive material, the patterning of the light shade layer 110 may be achieved by exposing the light shade layer 110 to light using a photomask (not illustrated) having a predetermined pattern. On the other hand, when the light shade layer 110 is formed of a non-photosensitive material, photoresist (not illustrated) is coated on the surface of the light shade layer 110 and the light shade layer 110 may be patterned by lithography. The light shade layer 110 may be etched using the patterned photoresist as an etch mask. The patterned light shade layer 120′ may be about 1.5 μm in height and about 30 μm in width.

Thereafter, the patterned light shade layer 120′ is hard baked. The hard baking may be performed at about 200-230° C. for about 20-40 minutes. While the patterned light shade layer 120′ is being hard baked, the nano-sized grooves 130 (see FIG. 4D) may be formed on the upper surface of the patterned light shade layer 120′ using a nano-imprinting process.

More specifically, referring to FIG. 4C, first, a stamp 150 is installed over the patterned light shade layer 120′. The stamp 150 has nano-sized protrusions 160 formed on its bottom. The stamp 150 may be formed of a material selected from the group consisting of glass, quartz, silicon (Si), and poly(dimethylsiloxane) (PDMS). Next, when the stamp 150 is pressed down on the upper surface of the patterned light shade layer 120′, the protrusions 160 formed on the bottom surface of the stamp 150 enter into the upper surface of the patterned light shade layer 120′, so that the grooves 130 (see FIG. 4D) having shapes depending on the shapes of the protrusions 160 are formed in the upper surface of the patterned light shade layer 120′. At this time, since the patterned light shade layer 120′ may be rendered soft during the hard baking, the protrusions 160 of the stamp 150 can easily squeeze into the upper surface of the patterned light shade layer 120′.

As illustrated in FIG. 4D, when the stamp 150 is taken away, the black matrix 120 is completely formed in the patterned light shade layer 120′. The grooves 130 formed on the upper surface 120a of the black matrix 120 using the nano-imprinting process may be about 20-200 nm in size and about 1000-100000 nm²² in cross-sectional area, for example 5000-10000 nm². The grooves 130 may occupy 20-50% of the upper surface 120a of the black matrix 120. The depth of each of the grooves 130 may be about 50-200 nm. As described above, when the nano-sized grooves 130 are formed on the upper surface 120a of the black matrix 120, the upper surface 120a is rendered ink-phobic, and the lateral surfaces 120b of the black matrix 120 are kept ink-philic.

Although a black matrix for a color filter usually used in LCDs and a method of fabricating the black matrix have been illustrated, the structure of the black matrix and the fabrication thereof may be equally applied to banks that are used in organic ELs (OLEDs).

As described above, the upper surface of a black matrix according to the present general inventive concept may be rendered ink-phobic by making the upper surface of the black matrix to have a concave-convex structure using a physical method. Thus, when a color filter is manufactured using the black matrix, ink mixture between pixels of the color filter can be prevented. Furthermore, since the lateral surfaces of the black matrix are kept ink-philic, the color reproducibility and contrast ratio of the color filter can be improved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A black matrix used with color filters that is formed on a substrate and defines a plurality of pixel regions, the black matrix comprising:
an upper surface having a plurality of nano-sized grooves formed therein and being ink-phobic; and
lateral surfaces being ink-philic.

2. The black matrix for color filters of claim 1, wherein the black matrix is formed of an ink-philic material.

3. The black matrix for color filters of claim 2, wherein the black matrix is formed of a polymer-based organic resin.

4. The black matrix for color filters of claim 1, wherein each of the grooves is 20-200 nm in size.

5. The black matrix for color filters of claim 4, wherein each of the grooves is 1000-100000 nm² in cross-sectional area.

6. The black matrix for color filters of claim 4, wherein the grooves occupy 20-50% of the upper surface.

7. The black matrix for color filters of claim 4, wherein each of the grooves is 50-200 nm in depth.

8. A color filter comprising:
a substrate;
a black matrix formed on the substrate and defining a plurality of pixel regions; and
ink of predetermined colors filled within the pixel regions, wherein the black matrix comprises:
an upper surface having a plurality of nano-sized grooves formed therein and being ink-phobic, and
lateral surfaces being ink-philic.

9. The color filter of claim 8, wherein the black matrix is formed of an ink-philic material.

10. The color filter of claim 8, wherein each of the grooves is 20-200 nm in size.

11. The color filter of claim 10, wherein each of the grooves is 1000-100000 nm² in cross-sectional area.

12. The color filter of claim 10, wherein the grooves occupy 20-50% of the upper surface of the black matrix.

13. The color filter of claim 10, wherein each of the grooves is 50-200 nm in depth.

14. A method of manufacturing a black matrix used with color filters, the method comprising:
forming a light shade layer of an ink-philic material on a substrate;
patterning the light shade layer to define a plurality of pixel regions on the substrate; and
forming a black matrix by forming nano-sized grooves on an upper surface of the patterned light shade layer using a nano-imprinting process.

15. The method of claim 14, wherein the light shade layer is formed of a polymer-based organic resin.

16. The method of claim 14, wherein the forming of the light shade layer comprises:
coating the ink-philic material on the substrate; and
soft baking the ink-philic material.

17. The method of claim 16, wherein the soft baking is performed at 80-120° C.

18. The method of claim 14, further comprising:
hard baking the patterned light shade layer after the patterning of the light shade layer.

19. The method of claim 18, wherein the hard baking is performed at about 200-230° C.

20. The method of claim 18, wherein the nano-imprinting process is executed during the hard baking of the patterned light shade layer.

21. The method of claim 14, wherein the forming of the grooves using the nano-imprinting process comprises:
installing a stamp over the patterned light shade layer, the stamp having nano-sized protrusions formed on its bottom;
pressing the stamp down on the upper surface of the patterned light shade layer so as to form grooves having shapes depending on the shapes of the protrusions on the stamp in the upper surface of the patterned light shade layer; and
separating the stamp from the light shade layer.

22. The method of claim 21, wherein the stamp is formed of a material selected from the group consisting of glass, quartz, silicon (Si), and poly(dimethylsiloxane) (PDMS).

23. The method of claim 14, wherein each of the grooves is formed to have a size of 20-200 nm.

24. The method of claim 23, wherein each of the grooves is formed to have a cross-sectional area of 1000-100000 nm².

25. The method of claim 23, wherein the grooves occupy 20-50% of the upper surface of the black matrix.

26. The method of claim 23, wherein each of the grooves is formed to have a depth of 50-200 nm.

27. A black matrix used with a color filter defining a plurality of pixel regions, the black matrix comprising:
an ink-phobic upper surface; and
ink-philic lateral surfaces formed of a same material as the upper surface.

28. The black matrix of claim 27, wherein the black matrix is formed of a ink-phillic material.

29. The black matrix of claim 27, wherein the ink-phobic upper surface comprises a plurality of grooves.

30. The black matrix of claim 29, wherein each of the plurality of grooves is 20-200 nm in diameter.

31. The black matrix of claim 29, wherein the distance between inner walls of the plurality of grooves is 20-200 nm.

32. The black matrix of claim 29, wherein each of the plurality of grooves is 50-200 nm in depth.

33. The black matrix of claim 29, wherein the plurality of grooves occupy 20-50% of a total area of the upper surface of the black matrix.

34. A method of manufacturing a black matrix used with a color filter, the method comprising:
patterning a layer on a substrate to define a plurality of pixel regions;
forming a plurality of nano-sized grooves on a top surface of the patterned layer to form ink-phobic regions.

35. The method of claim 34 wherein the patterned layer comprises an ink-philic material, and the patterning of the layer comprises:
coating the ink-philic material on the substrate; and
soft-baking the ink-philic material on the substrate.

36. The method of claim 34, wherein the patterning of the layer further comprises:
hard-baking the patterned layer.

37. The method of claim 36, wherein the forming of the plurality of grooves comprises:
pressing a stamp having a plurality of protrusions onto the top surface of the patterned layer.

38. The method of claim 37, wherein the forming of the plurality of grooves is performed during the hard-baking of the patterned layer.

39. The method of claim 35, wherein the forming of the plurality of grooves is performed during the soft-baking of the patterned layer.

40. The method of claim 34, wherein each of the grooves is formed to have a size of 20-200 nm.

41. The method of claim 34, wherein each of the grooves is formed to have a cross-sectional area of 1000-100000 nm².

42. The method of claim 34, wherein each of the grooves is formed to have a depth of 50-200 nm.

43. The method of claim 34, wherein the grooves is formed to occupy 20-50% of the upper surface of the layer.
